(19) United States
(12) Patent Application Publication
(10) Pub. No.: US 2019/0044819 A1
(43) Pub. Date: Feb. 7, 2019

(54) TECHNOLOGY TO ACHIEVE FAULT TOLERANCE FOR LAYERED AND DISTRIBUTED STORAGE SERVICES

(71) Applicant: Intel Corporation, Santa Clara, CA (US)

(72) Inventors: Anjaneya Chagam Reddy, Chandler, AZ (US); Mohan Kumar, Aloha, OR (US)

(21) Appl. No.: 15/938,154

(22) Filed: Mar. 28, 2018

(51) Int. Cl. H04L 12/24; H04L 29/08

(52) U.S. Cl. CPC H04L 41/12; H04L 41/06; H04L 67/1097

(57) ABSTRACT

Systems, apparatuses and methods may provide for technology to identify a first set of fault domains associated with data nodes in a data distribution framework and identify a second set of fault domains associated with storage nodes in a data storage framework, wherein the data distribution framework overlays and is different from the data storage framework. Moreover, a mapping data structure may be generated based on the first and second sets of fault domains, wherein the mapping data structure associates data nodes and storage nodes that share fault domains with one another. In one example, the fault domains are storage racks.

### TECHNICAL FIELD

Embodiments generally relate to storage services.

### BACKGROUND

In distributed file systems, data distribution may be managed by a different framework than the framework that manages data storage. Each framework may create replicas of data, which may lead to more replicas than are needed and increased storage costs. Moreover, the independent operation of the frameworks may make single points of failure more likely.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a consolidated storage service topology according to an embodiment;

FIG. 2 is a flowchart of an example of a method of consolidating a data distribution framework with a data storage framework according to an embodiment;

FIG. 3 is a flowchart of an example of a more detailed method of consolidating a data distribution framework with a data storage framework according to an embodiment;

FIG. 4 is a flowchart of an example of a method of provisioning data volumes according to an embodiment;

FIG. 5 is a block diagram of an example of a conventional provisioning result compared to an enhanced provisioning result according to an embodiment;

FIG. 6 is a block diagram of an example of a computing system according to an embodiment; and

FIG. 7 is an illustration of an example of a semiconductor package apparatus according to an embodiment.

### DESCRIPTION OF EMBODIMENTS

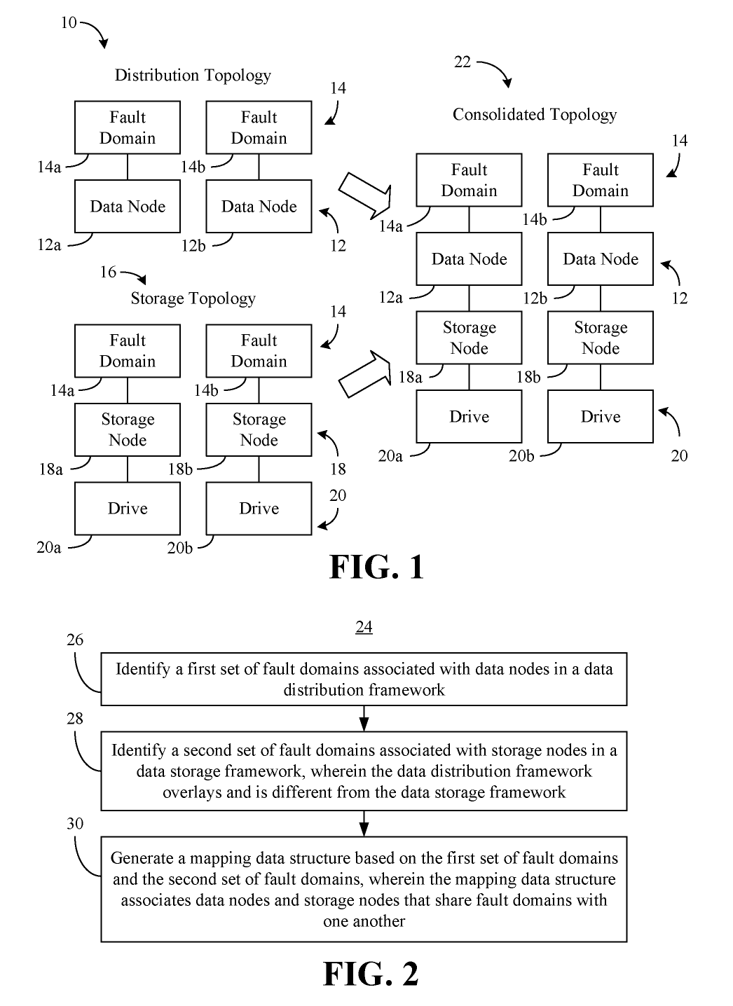

Turning now to FIG. 1, a distribution topology 10 is shown, wherein the distribution topology 10 may be generated by a framework that manages data distribution (e.g., data distribution framework) for a plurality of data nodes 12 (12a, 12b). The data nodes 12 may generally be associated with fault domains 14 (14a, 14b, e.g., storage racks). In the illustrated example, a first data node 12a is associated with a first fault domain 14a and a second data node 12b is associated with a second fault domain 14b. Thus, if a failure (e.g., power outage, switch error, etc.) is encountered in the first fault domain 14a, the second fault domain 14b may continue to be operational, and vice versa. To avoid a single point of failure (e.g., complete loss of data), the data distribution framework might assign a particular portion (e.g., shard) of a data volume to the first data node 12a and assign a replica (e.g., backup copy) of the data volume portion to the second data node 12b.

Additionally, a storage topology 16 may be generated by a framework that manages data storage (e.g., data storage framework, wherein the data distribution framework overlays and is different from the data storage framework) for a plurality of storage nodes 18 (18a, 18b). The storage nodes 18 may generally be associated with the fault domains 14 and drives 20 (20a, 20b, e.g., hard disk drive/HDD, solid state drive/SSD, optical disc, flash memory, etc.). In the illustrated example, a first storage node 18a is associated with the first fault domain 14a and a first drive 20a. Additionally, a second storage node 18b may be associated with the second fault domain 14b and a second drive 20b. Of particular note is that the data storage framework may natively be unaware if a given shard is a replica of another shard because the data storage framework and the data distribution framework are separate from one another (e.g., operating under different and independent clustering schemes). Accordingly, the data storage framework may not inherently know that assigning certain shards to the same storage node may create a single point of failure.

As will be discussed in greater detail, technology described herein may enable the data storage framework, which serves storage to the data distribution framework (e.g., the client) to be aware of client capabilities and data distribution semantics. Moreover, the data storage framework may leverage this knowledge to intelligently throttle data distribution (e.g., by local ephemeral mode, which automatically deletes excess copies of data) while avoiding single points of failure. More particularly, the fault domains 14 may be used to merge/consolidate the distribution topology 10 with the storage topology 16. The result may be a consolidated topology 22 that associates the data nodes 12 with the storage nodes 18 on the basis of shared fault domains 14.

For example, the first data node 12a may be automatically associated with the first storage node 18a because both the first data node 12a and the first storage node 18a share the first fault domain 14a. Similarly, the second data node 12b may be automatically associated with the second storage node 18b because both the second data node 12b and the second storage node 18b share the second fault domain 14b. As a result, the data storage framework may use the consolidated topology 22 to determine that assigning one shard to the first storage node 18a and assigning another shard to the second storage node 18b may avoid the creation of a single point of failure (e.g., if one shard is a replica of the other shard). The illustrated consolidated topology 22 may also reduce storage costs by enabling the elimination of excess replicas.

FIG. 2 shows a method 24 of consolidating a data distribution framework with a data storage framework. The method 24 may be implemented in one or more modules as a set of logic instructions stored in a machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

For example, computer program code to carry out operations shown in the method 24 may be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 26 may provide for identifying a first set of fault domains associated with data nodes in a data distribution framework. Block 28 may identify a second set of fault domains associated with storage nodes in a data storage framework, wherein the data distribution framework overlays and is different from the data storage framework. As already noted, the fault domains may be storage racks, although other fault domains (e.g., rooms, data centers) may be used. A mapping data structure (e.g., lookup table) may be generated at block 30 based on the first set of fault domains and the second set of fault domains. In the illustrated example, the mapping data structure associates data nodes and storage nodes that share fault domains with one another.

The mapping data structure, which may be maintained (e.g., stored) in a central cluster service (e.g., distributed cluster) that all storage nodes are able to access, therefore provides a consistent view of the associations (e.g., map) even when there are changes in the underlying infrastructure (e.g., storage node down). More particularly, block 30 may include may include detecting a reconfiguration of the storage nodes in the data storage framework and repeating the method 24 in response to the reconfiguration to update the mapping data structure. The reconfiguration may be detected in, for example, one or more communications from the storage nodes. Accordingly, the mapping data structure may continue to associate data nodes and storage nodes that share fault domains with one another after one or more reconfigurations of the storage nodes.

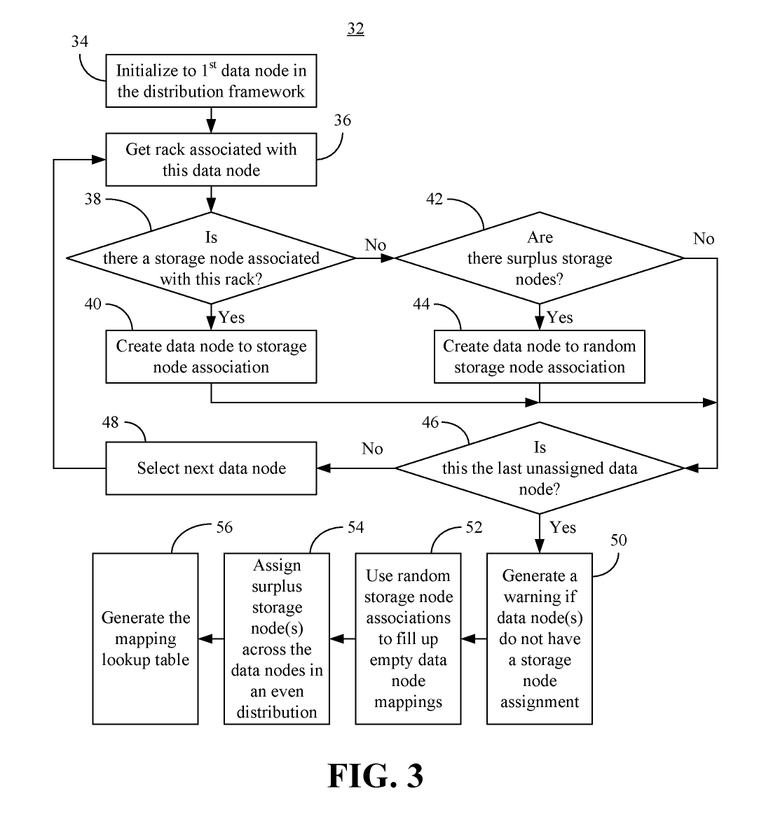

FIG. 3 shows a more detailed method 32 of consolidating a data distribution framework with a data storage framework. The method 32 may generally be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated processing block 34 initializes to the first data node in the distribution framework, wherein the storage rack associated with that data node may be identified at block 36. Block 38 may determine whether there is a storage node associated with the identified rack. If so, illustrated block 40 creates a data node to storage node association (e.g., keeping affinity). Once the association is created, the method 32 may proceed to block 46. If it is determined at block 38 that there is no storage node associated with the identified rack, a determination may be made at block 42 as to whether there are one or more surplus (e.g., unassigned) storage nodes. If surplus storage nodes are identified at block 42, illustrated block 44 creates a data node to random storage node association. More particularly, block 44 may randomly assign the surplus storage node(s) to the unassigned data node(s). Once the association is created, the method 32 may proceed to block 46. If surplus storage nodes are not detected at block 42, the method 32 may proceed directly to illustrated block 46, which determines whether the last unassigned data node has been encountered. If not, block 48 may select the next data node and the illustrated method 32 returns to block 36.

If it is determined at block 46 that the last unassigned data node has been encountered, illustrated block 50 provides for generating a warning if one or more data nodes do not have a storage node assignment in the mapping data structure. Additionally, the random storage node associations from block 44 may be used at block 52 to fill up empty data node mappings. Block 54 may identify one or more surplus storage nodes that do not have a data node assignment and assign the surplus storage node(s) across the data nodes in an even distribution. Thus, if there are ten surplus storage nodes and five data nodes, the even distribution may result in each data node being assigned two surplus storage nodes. The mapping lookup table (e.g., data structure) may be generated at block 56. As already noted, block 56 may include maintaining the mapping lookup table in a central cluster service that all storage nodes are able to access. Moreover, the mapping lookup table may provide a consistent view of the map even when there are changes in the underlying infrastructure (e.g., storage node down).

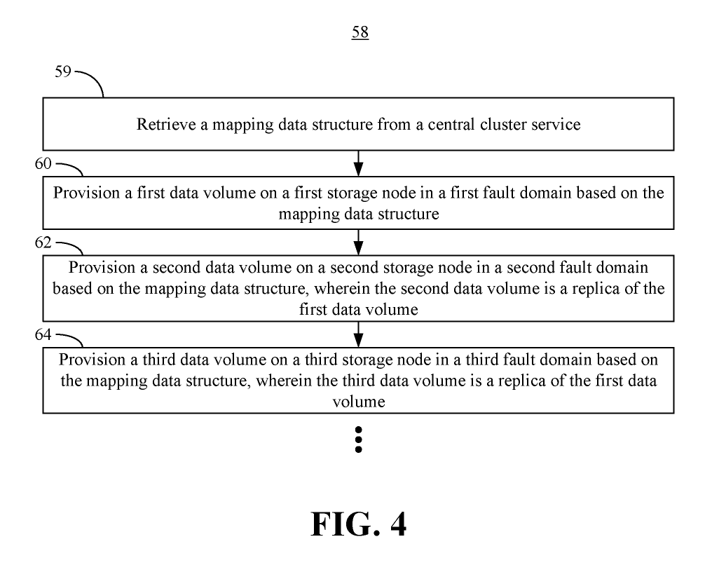

FIG. 4 shows a method 58 of provisioning data volumes (e.g., attaching volumes). The method 58 may generally be implemented in one or more modules as a set of logic instructions stored in a machine- or computer-readable storage medium such as RAM, ROM, PROM, firmware, flash memory, etc., in configurable logic such as, for example, PLAs, FPGAs, CPLDs, in fixed-functionality hardware logic using circuit technology such as, for example, ASIC, CMOS, TTL technology, or any combination thereof.

Illustrated processing block 59 provides for retrieving a mapping data structure such as, for example, the mapping data structure resulting from the method 24 (FIG. 2) and/or the method 32 (FIG. 3), already discussed, from a central cluster service. Block 59 may include sending one or more messages to the central cluster service, wherein the message(s) indicate that a storage node reconfiguration has taken place and the message(s) trigger an update of the mapping data structure. Block 60 may provision a first data volume (e.g., virtual volume) on a first storage node in a first fault domain based on the mapping data structure. Additionally, a second data volume may be provisioned at block 62 on a second storage node in a second fault domain based on the mapping data structure, wherein the second data volume is a replica of the first data volume. Block 64 may provision a third data volume on a third storage node in a third fault domain based on the mapping data structure, wherein the third data volume is a replica of the first data volume. Thus, the illustrated method 58 enables a single point of failure to be avoided.

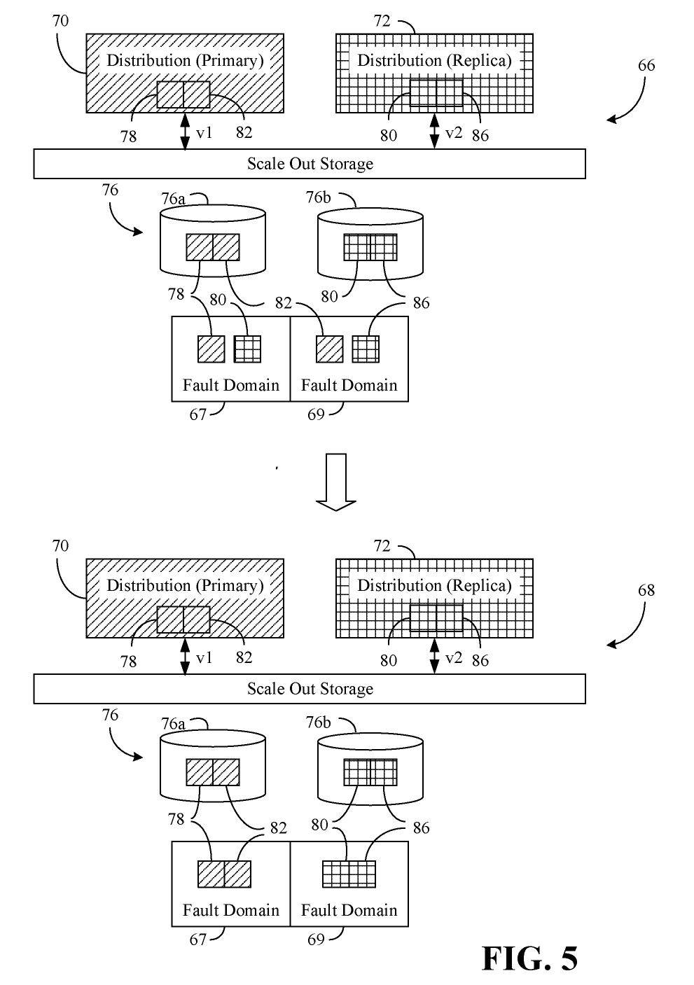

FIG. 5 shows a conventional provisioning result 66 and an enhanced provisioning result 68. In the illustrated example, a data distribution framework such as, for example, Hadoop Distributed File System (HDFS), Cassandra File System (CFS), MongoDB, etc., creates a primary volume 70 (v1) and a replica volume 72 (v2). In the illustrated example, the primary volume 70 includes a shard 78 and a shard 82. Additionally, the replica volume 72 may include a shard 80 that is a replica of the shard 78 and a shard 86 that is a replica of the shard 82. A data storage framework such as, for example, Ceph Rados Block Device (RBD), may define a plurality of virtual drives 76 (76a-76b) to be used as scale out storage. In the conventional provisioning result 66, both the shard 78 from the primary volume 70 and the replica shard 80 from the first replica volume 72 are stored in a common fault domain 67 (e.g., the same storage node), which may represent a single point of failure for the shards 78, 80. Similarly, both the shard 82 from the primary volume 70 and the replica shard 86 from the replica volume 72 are stored to a common fault domain 69, which may represent a single point of failure for the shards 82, 86.

By contrast, the enhanced provisioning result 68 provides for the shards 78, 82 from the primary volume 70 to be stored together on the common fault domain 67, and for the shards 80, 86 from the first replica volume 72 to be stored together on the common fault domain 69. Accordingly, the illustrated provisioning result 68 renders enhanced performance to the extent that single points of failure may be eliminated. Furthermore, storage costs may be reduced by eliminating excess replicas. As a result, storage media such as flash memory may be used to implement the fault domains 67 and 69, without concern over storage expense.

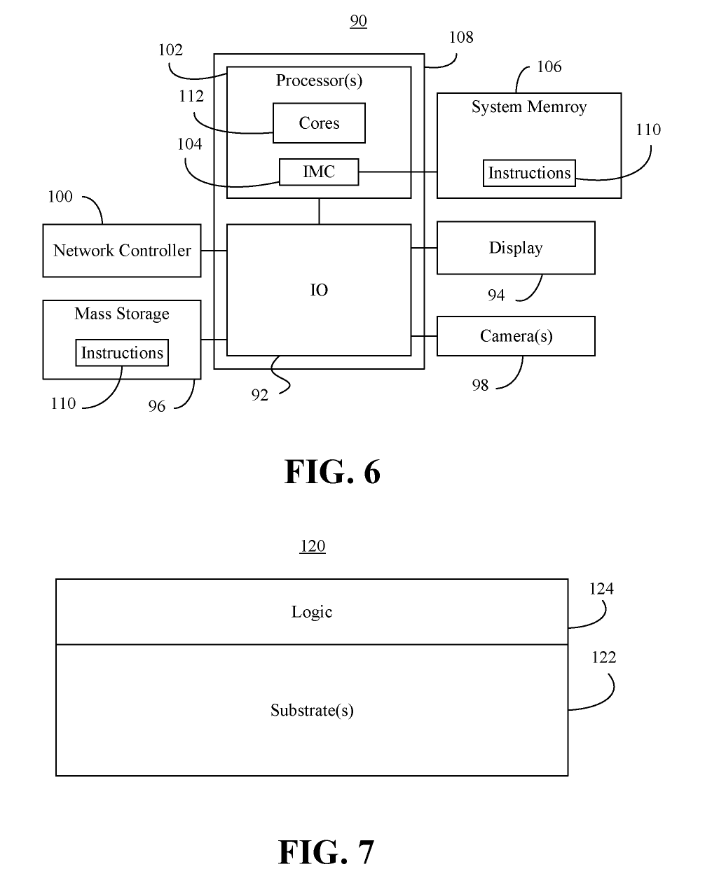

Turning now to FIG. 6, a performance-enhanced computing system 90 (e.g., central cluster service/server) is shown. The system 90 may be part of a server, desktop computer, notebook computer, tablet computer, convertible tablet, smart television (TV), personal digital assistant (PDA), mobile Internet device (MID), smart phone, wearable device, media player, vehicle, robot, etc., or any combination thereof. In the illustrated example, an input/output (IO) module 92 is communicatively coupled to a display 94 (e.g., liquid crystal display/LCD, light emitting diode/LED display, touch screen), mass storage 96 (e.g., hard disk drive/HDD, optical disk, flash memory, solid state drive/SSD), one or more cameras 98 and a network controller 100 (e.g., wired, wireless).

The system 90 may also include a processor 102 (e.g., central processing unit/CPU) that includes an integrated memory controller (IMC) 104, wherein the illustrated IMC 104 communicates with a system memory 106 over a bus or other suitable communication interface. The processor 102 and the I0 module 92 may be integrated onto a shared semiconductor die 108 in a system on chip (SoC) architecture.

In one example, the system memory 106 and/or the mass storage 96 include instructions 110, which when executed by one or more cores 112 of the processor(s) 102, cause the system 90 to conduct the method 24 (FIG. 2), the method 32 (FIG. 3) and/or the method 58 (FIG. 4), already discussed. Thus, execution of the instructions 110 may cause the system 90 to identify a first set of fault domains associated with data nodes in a data distribution framework and identify a second set of fault domains associated with storage nodes in a data storage framework, wherein the data distribution framework overlays and is different from the data storage framework. Additionally, execution of the instructions 110 may cause the system 90 to generate a mapping data structure (e.g., lookup table) based on the first set of fault domains and the second set of fault domains, wherein the mapping data structure associates data nodes and storage nodes that share fault domains with one another. The mapping data structure may be stored to the system memory 106 and/or the mass storage 96, presented on the display 94, transmitted via the network controller, and so forth. The mapping data structure may also be used by the distributed storage framework to provision data volumes. In one example, the fault domains are storage racks.

The memory structures of the system memory 106 and/or the mass storage 96 may include either volatile memory or non-volatile memory. Non-volatile memory is a storage medium that does not require power to maintain the state of data stored by the medium. In one embodiment, a memory structure is a block addressable storage device, such as those based on NAND or NOR technologies. A storage device may also include future generation nonvolatile devices, such as a three dimensional (3D) crosspoint memory device, or other byte addressable write-in-place nonvolatile memory devices. In one embodiment, the storage device may be or may include memory devices that use silicon-oxide-nitride-oxide-silicon (SONOS) memory, electrically erasable programmable read-only memory (EEPROM), chalcogenide glass, multi-threshold level NAND flash memory, NOR flash memory, single or multi-level Phase Change Memory (PCM), a resistive memory, nanowire memory, ferroelectric transistor random access memory (FeTRAIVI), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The storage device may refer to the die itself and/or to a packaged memory product. In some embodiments, 3D crosspoint memory may comprise a transistor-less stackable cross point architecture in which memory cells sit at the intersection of word lines and bit lines and are individually addressable and in which bit storage is based on a change in bulk resistance. In particular embodiments, a memory module with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at jedec.org).

Volatile memory is a storage medium that requires power to maintain the state of data stored by the medium. Examples of volatile memory may include various types of random access memory (RAM), such as dynamic random access memory (DRAM) or static random access memory (SRAM). One particular type of DRAM that may be used in a memory module is synchronous dynamic random access memory (SDRAM). In particular embodiments, DRAM of the memory modules complies with a standard promulgated by JEDEC, such as JESD79F for Double Data Rate (DDR) SDRAM, JESD79-2F for DDR2 SDRAM, JESD79-3F for DDR3 SDRAM, or JESD79-4A for DDR4 SDRAM (these standards are available at www.jedec.org). Such standards (and similar standards) may be referred to as DDR-based standards and communication interfaces of the storage devices that implement such standards may be referred to as DDR-based interfaces.

FIG. 7 shows a semiconductor package apparatus 120 (e.g., chip, die) that includes one or more substrates 122 (e.g., silicon, sapphire, gallium arsenide) and logic 124 (e.g., transistor array and other integrated circuit/IC components) coupled to the substrate(s) 122. The logic 124, which may be implemented at least partly in configurable logic and/or fixed-functionality hardware logic, may generally implement one or more aspects of the method 24 (FIG. 2), the method 32 (FIG. 3) and/or the method 58 (FIG. 4), already discussed. Thus, the logic 124 may identify a first set of fault domains associated with data nodes in a data distribution framework and identify a second set of fault domains associated with storage nodes in a data storage framework, wherein the data distribution framework overlays and is different from the data storage framework. Additionally, the logic 124 may generate a mapping data structure (e.g., lookup table) based on the first set of fault domains and the second set of fault domains, wherein the mapping data structure associates data nodes and storage nodes that share fault domains with one another. The fault domains may be storage racks.

In one example, the logic 124 includes transistor channel regions that are positioned (e.g., embedded) within the substrate(s) 122. Thus, the interface between the logic 124 and the substrate(s) 122 may not be an abrupt junction. The logic 124 may also be considered to include an epitaxial layer that is grown on an initial wafer of the substrate(s) 122.

### ADDITIONAL NOTES AND EXAMPLES

Example 1 may include a performance-enhanced computing system comprising a network controller, a processor coupled to the network controller, and a memory coupled to the processor, the memory including a set of instructions, which when executed by the processor, cause the computing system to identify a first set of fault domains associated with data nodes in a data distribution framework, identify a second set of fault domains associated with storage nodes in a data storage framework, wherein the data distribution framework overlays and is different from the data storage framework, and generate a mapping data structure based on the first set of fault domains and the second set of fault domains, wherein the mapping data structure associates data nodes and storage nodes that share fault domains with one another.

Example 2 may include the computing system of Example 1, wherein the first set of fault domains and the second set of fault domains are to be storage racks.

Example 3 may include the computing system of Example 1, wherein the instructions, when executed, cause the computing system to identify one or more unassigned data nodes that do not share a fault domain with any of the storage nodes, identify one or more surplus storage nodes that do not have a data node assignment, and randomly assign the one or more surplus storage nodes to the one or more unassigned data nodes.

Example 4 may include the computing system of Example 1, wherein the instructions, when executed, cause the computing system to identify one or more surplus storage nodes that do not have a data node assignment, and assign the one or more surplus storage nodes across the data nodes in an even distribution.

Example 5 may include the computing system of Example 1, wherein the instructions, when executed, cause the computing system to generate a warning if one or more of the data nodes do not have a storage node assignment in the mapping data structure.

Example 6 may include the computing system of Example 1, wherein the mapping data structure is to be maintained on a central cluster service, and wherein the instructions, when executed, cause the computing system to retrieve the mapping data structure from the central cluster service, provision a first data volume on a first storage node in a first fault domain based on the mapping data structure, provision a second data volume on a second storage node in a second fault domain based on the mapping data structure, wherein the second data volume is to be a replica of the first data volume, and provision a third data volume on a third storage node in a third fault domain based on the mapping data structure, wherein the third data volume is to be a replica of the first data volume.

Example 7 may include a semiconductor apparatus comprising one or more substrates, and logic coupled to the one or more substrates, wherein the logic is implemented at least partly in one or more of configurable logic or fixed-functionality hardware logic, the logic coupled to the one or more substrates to identify a first set of fault domains associated with data nodes in a data distribution framework, identify a second set of fault domains associated with storage nodes in a data storage framework, wherein the data distribution framework overlays and is different from the data storage framework, and generate a mapping data structure based on the first set of fault domains and the second set of fault domains, wherein the mapping data structure associates data nodes and storage nodes that share fault domains with one another.

Example 8 may include the semiconductor apparatus of Example 7, wherein the first set of fault domains and the second set of fault domains are to be storage racks.

Example 9 may include the semiconductor apparatus of Example 7, wherein the logic coupled to the one or more substrates is to identify one or more unassigned data nodes that do not share a fault domain with any of the storage nodes, identify one or more surplus storage nodes that do not have a data node assignment, and randomly assign the one or more surplus storage nodes to the one or more unassigned data nodes.

Example 10 may include the semiconductor apparatus of Example 7, wherein the logic coupled to the one or more substrates is to identify one or more surplus storage nodes that do not have a data node assignment, and assign the one or more surplus storage nodes across the data nodes in an even distribution.

Example 11 may include the semiconductor apparatus of Example 7, wherein the logic coupled to the one or more substrates is to generate a warning if one or more of the data nodes do not have a storage node assignment in the mapping data structure.

Example 12 may include the semiconductor apparatus of Example 7, wherein the mapping data structure is to be maintained on a central cluster service, and wherein the logic coupled to the one or more substrates is to retrieve the mapping data structure from the central cluster service, provision a first data volume on a first storage node in a first fault domain based on the mapping data structure, provision a second data volume on a second storage node in a second fault domain based on the mapping data structure, wherein the second data volume is to be a replica of the first data volume, and provision a third data volume on a third storage node in a third fault domain based on the mapping data structure, wherein the third data volume is to be a replica of the first data volume.

Example 13 may include a method of consolidating frameworks, comprising identifying a first set of fault domains associated with data nodes in a data distribution framework, identifying a second set of fault domains associated with storage nodes in a data storage framework, wherein the data distribution framework overlays and is different from the data storage framework, and generating a mapping data structure based on the first set of fault domains and the second set of fault domains, wherein the mapping data structure associates data nodes and storage nodes that share fault domains with one another.

Example 14 may include the method of Example 13, wherein the first set of fault domains and the second set of fault domains are storage racks.

Example 15 may include the method of Example 13, wherein generating the mapping data structure includes identifying one or more unassigned data nodes that do not share a fault domain with any of the storage nodes, identifying one or more surplus storage nodes that do not have a data node assignment, and randomly assigning the one or more surplus storage nodes to the one or more unassigned data nodes.

Example 16 may include the method of Example 13, wherein generating the mapping data structure includes identifying one or more surplus storage nodes that do not have a data node assignment, and assigning the one or more surplus storage nodes across the data nodes in an even distribution.

Example 17 may include the method of Example 13, further including generating a warning if one or more of the data nodes do not have a storage node assignment in the mapping data structure.

Example 18 may include the method of Example 13, wherein the mapping data structure is maintained on a central cluster service, the method further including retrieving the mapping data structure from the central cluster service, provisioning a first data volume on a first storage node in a first fault domain based on the mapping data structure, provisioning a second data volume on a second storage node in a second fault domain based on the mapping data structure, wherein the second data volume is a replica of the first data volume, and provisioning a third data volume on a third storage node in a third fault domain based on the mapping data structure, wherein the third data volume is a replica of the first data volume.

Example 19 may include at least one computer readable storage medium comprising a set of instructions, which when executed by a computing system, cause the computing system to identify a first set of fault domains associated with data nodes in a data distribution framework, identify a second set of fault domains associated with storage nodes in a data storage framework, wherein the data distribution framework overlays and is different from the data storage framework, and generate a mapping data structure based on the first set of fault domains and the second set of fault domains, wherein the mapping data structure associates data nodes and storage nodes that share fault domains with one another.

Example 20 may include the at least one computer readable storage medium of Example 19, wherein the first set of fault domains and the second set of fault domains are to be storage racks.

Example 21 may include the at least one computer readable storage medium of Example 19, wherein the instructions, when executed, cause the computing system to identify one or more unassigned data nodes that do not share a fault domain with any of the storage nodes, identify one or more surplus storage nodes that do not have a data node assignment, and randomly assign the one or more surplus storage nodes to the one or more unassigned data nodes.

Example 22 may include the at least one computer readable storage medium of Example 19, wherein the instructions, when executed, cause the computing system to identify one or more surplus storage nodes that do not have a data node assignment, and assign the one or more surplus storage nodes across the data nodes in an even distribution.

Example 23 may include the at least one computer readable storage medium of Example 19, wherein the instructions, when executed, cause the computing system to generate a warning if one or more of the data nodes do not have a storage node assignment in the mapping data structure.

Example 24 may include the at least one computer readable storage medium of Example 19, wherein the mapping data structure is to be maintained on a central cluster service, and wherein the instructions, when executed, cause the computing system to retrieve the mapping data structure from the central cluster service, provision a first data volume on a first storage node in a first fault domain based on the mapping data structure, provision a second data volume on a second storage node in a second fault domain based on the mapping data structure, wherein the second data volume is to be a replica of the first data volume, and provision a third data volume on a third storage node in a third fault domain based on the mapping data structure, wherein the third data volume is to be a replica of the first data volume.

Example 25 may include the at least one computer readable storage medium of Example 19, wherein the instructions, when executed, cause the computing system to detect a reconfiguration of the storage nodes in the data storage framework, and update the mapping data structure in response to the reconfiguration.

Technology described herein may therefore avoid the storage of excess data copies to achieve fault tolerance and reduce total cost of ownership (TCO) significantly. Moreover, the technology enables flash as viable option for distributed analytics frameworks using common data lake storage architectures.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a memory coupled to the processor, the memory including a set of instructions, which when executed by the processor, cause the computing system to:
identify a first set of fault domains associated with data nodes in a data distribution framework,
identify a second set of fault domains associated with storage nodes in a data storage framework, wherein the data distribution framework overlays and is different from the data storage framework, and
generate a mapping data structure based on the first set of fault domains and the second set of fault domains, wherein the mapping data structure associates data nodes and storage nodes that share fault domains with one another.

2. The computing system of claim 1, wherein the first set of fault domains and the second set of fault domains are to be storage racks.

3. The computing system of claim 1, wherein the instructions, when executed, cause the computing system to:
identify one or more unassigned data nodes that do not share a fault domain with any of the storage nodes;
identify one or more surplus storage nodes that do not have a data node assignment; and
randomly assign the one or more surplus storage nodes to the one or more unassigned data nodes.

4. The computing system of claim 1, wherein the instructions, when executed, cause the computing system to:
identify one or more surplus storage nodes that do not have a data node assignment; and
assign the one or more surplus storage nodes across the data nodes in an even distribution.

5. The computing system of claim 1, wherein the instructions, when executed, cause the computing system to generate a warning if one or more of the data nodes do not have a storage node assignment in the mapping data structure.

6. The computing system of claim 1, wherein the mapping data structure is to be maintained on a central cluster service, and wherein the instructions, when executed, cause the computing system to:
retrieve the mapping data structure from the central cluster service;
provision a first data volume on a first storage node in a first fault domain based on the mapping data structure;
provision a second data volume on a second storage node in a second fault domain based on the mapping data structure, wherein the second data volume is to be a replica of the first data volume; and
provision a third data volume on a third storage node in a third fault domain based on the mapping data structure, wherein the third data volume is to be a replica of the first data volume.

7. A semiconductor apparatus comprising:
one or more substrates; and
logic coupled to the one or more substrates, wherein the logic is implemented at least partly in one or more of configurable logic or fixed-functionality hardware logic, the logic coupled to the one or more substrates to:
identify a first set of fault domains associated with data nodes in a data distribution framework,
identify a second set of fault domains associated with storage nodes in a data storage framework, wherein the data distribution framework overlays and is different from the data storage framework, and
generate a mapping data structure based on the first set of fault domains and the second set of fault domains, wherein the mapping data structure associates data nodes and storage nodes that share fault domains with one another.

8. The semiconductor apparatus of claim 7, wherein the first set of fault domains and the second set of fault domains are to be storage racks.

9. The semiconductor apparatus of claim 7, wherein the logic coupled to the one or more substrates is to:
identify one or more unassigned data nodes that do not share a fault domain with any of the storage nodes,
identify one or more surplus storage nodes that do not have a data node assignment, and
randomly assign the one or more surplus storage nodes to the one or more unassigned data nodes.

10. The semiconductor apparatus of claim 7, wherein the logic coupled to the one or more substrates is to:
identify one or more surplus storage nodes that do not have a data node assignment, and assign the one or more surplus storage nodes across the data nodes in an even distribution.

11. The semiconductor apparatus of claim 7, wherein the logic coupled to the one or more substrates is to generate a warning if one or more of the data nodes do not have a storage node assignment in the mapping data structure.

12. The semiconductor apparatus of claim 7, wherein the mapping data structure is to be maintained on a central cluster service, and wherein the logic coupled to the one or more substrates is to:
retrieve the mapping data structure from the central cluster service,
provision a first data volume on a first storage node in a first fault domain based on the mapping data structure,
provision a second data volume on a second storage node in a second fault domain based on the mapping data structure, wherein the second data volume is to be a replica of the first data volume, and
provision a third data volume on a third storage node in a third fault domain based on the mapping data structure, wherein the third data volume is to be a replica of the first data volume.

13. A method comprising:
identifying a first set of fault domains associated with data nodes in a data distribution framework;
identifying a second set of fault domains associated with storage nodes in a data storage framework, wherein the data distribution framework overlays and is different from the data storage framework; and
generating a mapping data structure based on the first set of fault domains and the second set of fault domains, wherein the mapping data structure associates data nodes and storage nodes that share fault domains with one another.

14. The method of claim 13, wherein the first set of fault domains and the second set of fault domains are storage racks.

15. The method of claim 13, wherein generating the mapping data structure includes:
identifying one or more unassigned data nodes that do not share a fault domain with any of the storage nodes;
identifying one or more surplus storage nodes that do not have a data node assignment; and
randomly assigning the one or more surplus storage nodes to the one or more unassigned data nodes.

16. The method of claim 13, wherein generating the mapping data structure includes:
identifying one or more surplus storage nodes that do not have a data node assignment; and
assigning the one or more surplus storage nodes across the data nodes in an even distribution.

17. The method of claim 13, further including generating a warning if one or more of the data nodes do not have a storage node assignment in the mapping data structure.

18. The method of claim 13, wherein the mapping data structure is maintained on a central cluster service, the method further including:
retrieving the mapping data structure from the central cluster service;
provisioning a first data volume on a first storage node in a first fault domain based on the mapping data structure;
provisioning a second data volume on a second storage node in a second fault domain based on the mapping data structure, wherein the second data volume is a replica of the first data volume; and
provisioning a third data volume on a third storage node in a third fault domain based on the mapping data structure, wherein the third data volume is a replica of the first data volume.

19. At least one computer readable storage medium comprising a set of instructions, which when executed by a computing system, cause the computing system to:
identify a first set of fault domains associated with data nodes in a data distribution framework;
identify a second set of fault domains associated with storage nodes in a data storage framework, wherein the data distribution framework overlays and is different from the data storage framework; and
generate a mapping data structure based on the first set of fault domains and the second set of fault domains, wherein the mapping data structure associates data nodes and storage nodes that share fault domains with one another.

20. The at least one computer readable storage medium of claim 19, wherein the first set of fault domains and the second set of fault domains are to be storage racks.

21. The at least one computer readable storage medium of claim 19, wherein the instructions, when executed, cause the computing system to:
identify one or more unassigned data nodes that do not share a fault domain with any of the storage nodes;
identify one or more surplus storage nodes that do not have a data node assignment; and
randomly assign the one or more surplus storage nodes to the one or more unassigned data nodes.

22. The at least one computer readable storage medium of claim 19, wherein the instructions, when executed, cause the computing system to:
identify one or more surplus storage nodes that do not have a data node assignment; and
assign the one or more surplus storage nodes across the data nodes in an even distribution.

23. The at least one computer readable storage medium of claim 19, wherein the instructions, when executed, cause the computing system to generate a warning if one or more of the data nodes do not have a storage node assignment in the mapping data structure.

24. The at least one computer readable storage medium of claim 19, wherein the mapping data structure is to be maintained on a central cluster service, and wherein the instructions, when executed, cause the computing system to:
retrieve the mapping data structure from the central cluster service;
provision a first data volume on a first storage node in a first fault domain based on the mapping data structure;
provision a second data volume on a second storage node in a second fault domain based on the mapping data structure, wherein the second data volume is to be a replica of the first data volume; and
provision a third data volume on a third storage node in a third fault domain based on the mapping data structure, wherein the third data volume is to be a replica of the first data volume.

25. The at least one computer readable storage medium of claim 19, wherein the instructions, when executed, cause the computing system to:
detect a reconfiguration of the storage nodes in the data storage framework; and
update the mapping data structure in response to the reconfiguration.
